(19) United States
(12) Patent Application Publication
(10) Pub. No.: US 2002/0198310 A1
(43) Pub. Date: Dec. 26, 2002

(54) Integrated process for preparing organoperoxide catalyst containing silicone rubber composition

(76) Inventors: Robert Lewis Bixler JR., Midland, MI (US); Susan Jane Gelderbloom, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 09/864,635

(22) Filed: May 25, 2001

(51) Int. Cl. C08J 3/00

(52) U.S. Cl. 524/588

(57) ABSTRACT

An integrated process for producing organoperoxide catalyst containing silicone rubber compositions with substantially reduced processing time and labor input compared to standard methods for producing such compositions. The process involves forming a powdered silicone rubber composition comprising a polydiorganosiloxane gum and a reinforcing filler, treating the reinforcing filler with a treating agent at a temperature greater than about 80° C., cooling the powdered silicone rubber composition by means of a bulk solid cooling apparatus, and admixing the cooled powdered silicone rubber with a peroxide catalyst either before, during, or after a massing step.

### FIELD OF THE INVENTION

The present invention is an integrated process for producing organoperoxide catalyst containing silicone rubber compositions with substantially reduced processing time and labor input compared to standard methods for producing such compositions.

### BACKGROUND OF INVENTION

The present invention is an integrated process for producing organoperoxide catalyst containing silicone rubber compositions with substantially reduced processing time and labor input compared to standard methods for producing such compositions. The process involves forming a powdered silicone rubber composition comprising a polydiorganosiloxane gum and a reinforcing filler, treating the reinforcing filler with a treating agent at a temperature greater than about 80° C., cooling the powdered silicone rubber composition by means of a bulk solid cooling apparatus, and admixing the cooled powdered silicone rubber with a peroxide catalyst either before, during, or after a massing step.

In the past to prepare peroxide curing silicone rubber compositions it was common to pre pare a polydiorganosiloxane gum having a viscosity of 1×10⁶ to 2×10⁸ mPa·s at 25° C. which was the basic ingredient of the peroxide curing silicone rubber composition. The gum was then transported to a dough-mixer. Then, there was added to the gum in the dough-mixer the requisite amount of reinforcing fillers or extending fillers, heat stabilizers, flame retardant additives, processing aids, and other types of ingredients that are normally associated or present in peroxide curing silicone rubber compositions.

The doughmixer comprises a large tank with two large mixing blades therein which agitate and mix the gum and the other ingredients into a uniform mixture. Normally, it takes a doughmixer from a minimum of 3 hours to a maximum of 48 hours to form a uniform homogeneous mass of the diorganopolysiloxane gum, filler, and other ingredients. After the dough mixing is completed the composition is cooled for several hours either in the doughmixer or after removing from the doughmixer. The resulting mass in then dumped into a cart, cut into pieces, and passed through an extruder to screen out particles and form into packageable 50 pound slabs. The resulting slabs are then packaged and shipped, or they may be processed through other extruding and forming machines before they are shipped. In addition, in some cases, the 50 pound slabs are processed on a mill at which point a curing catalyst may be added and the resulting milled mass can then be extruded into the desired shape and shipped as such. Or, in the alternative, the uncatalyzed mass may be shipped to the customer for subsequent addition of the peroxide catalyst.

The above described method is both time consuming and labor intensive and requires multiple manual handlings of the silicone rubber compositions during compounding and forming into a shippable form. The present process significantly shortens the time required to form the peroxide curable silicone rubber compositions and eliminates the manual handling of the silicone rubber compositions during compounding and forming into a shippable product. This reduction in time and elimination of manual handling is achieved by an integrated process comprising first forming a free-flowing particulate polymer mixture comprising in situ treated fumed silica and a high consistency polydiorganosiloxane, rapidly cooling the free-flowing powder by means of a bulk solids cooling apparatus, and then extruding the cooled free-flowing powder to effect massing, screening, and shaping of the silicone rubber composition into a form suitable for its intended use. The peroxide catalyst can be added to the silicone rubber composition at any stage after the cooling step, that is to the free-flowing powder, during the massing of the free-flowing powder, or as a separate mixing step, by for example an in-line distributive mixer attached to the exit of the extruder.

Link et al., U.S. Pat. No. 3,824,208, teach a process for producing a free-flowing particulate polymer mixture comprising a filler and a polymer having a viscosity from 1×10³ to 2×10⁸ centipoise at 25° C.

Bilgrien et al., U.S. Pat. No. 5,153,238, teach storage stable and gel-free organosiloxane compositions in the form of flowable powders prepared by blending a high consistency polydiorganosiloxane into a quantity of fluidized reinforcing filler that is heated to a temperature of from 100° C. to 200° C. prior to or immediately following introduction of the polydiorganosiloxane. The silica filler is typically treated with an anti-creping agent either prior to or during this blending process. The resultant mixture is heated while being subjected to shearing forces that reduce its average particle size to achieve a flowable powder.

Mueller, U.S. Pat. No. 5,167,274, teaches a bulk solid cooling apparatus suitable for cooling free-flowing solid particulates.

Saxton, U.S. Pat. No. 3,006,029; Gale, U.S. Pat. No. 4,419,014; and Fukumizu et al., U.S. Pat. No. 4,695,165; all described mixing/extruding devices which may have use in the present integrated process.

### SUMMARY OF INVENTION

The present invention is an integrated process for producing organoperoxide catalyst containing silicone rubber compositions with substantially reduced processing time and labor input compared to standard methods for producing such compositions. The process involves forming a powdered silicone rubber composition comprising a high consistency polydiorganosiloxane and a reinforcing filler, treating the reinforcing filler with a treating agent at a temperature greater than about 80° C., cooling the powdered silicone rubber composition by means of a bulk solid cooling apparatus, and admixing the cooled powdered silicone rubber with a peroxide catalyst either before, during, or after a massing step.

### BRIEF DESCRIPTION OF DRAWING

FIG. 1 is a schematic representation of an equipment configuration suitable for practicing the integrated process of the present invention

### DESCRIPTION OF INVENTION

The present invention is an integrated process for forming a peroxide catalyst containing silicone rubber composition comprising the steps of

A) forming a blend comprising i) 100 parts by weight of a high consistency polydiorganosiloxane, ii) about 10 to 80 parts by weight of a reinforcing silica filler, and iii) about 10 to 45 weight percent, based on the weight of the reinforcing silica filler, of a treating agent for the reinforcing filler, by maintaining the filler in a highly turbulent, fluidized state at a temperature of 80° C. to about 350° C. and maintaining the temperature and highly turbulent fluidized state while subjecting the blend to shearing force sufficient to achieve an average particle size of from 1 to 1000 microns thereby forming an organosiloxane composition in the form of a flowable powder,

B) facilitating accelerated bulk cooling of the organosiloxane composition in the form of a flowable powder to a temperature below the decomposition temperature of an organoperoxide catalyst added in step (D),

C) feeding the bulk cooled organosiloxane composition in the form of a flowable powder to an extruder and massing the composition therein at a temperature below the decomposition temperature of an organoperoxide catalyst added in step (D),

D) adding a catalytic amount of an organoperoxide catalyst to the organosiloxane composition either after step (B), or during or after step (C), at a temperature below the decomposition temperature of the organoperoxide catalyst, and

E) recovering an organoperoxide catalyst containing silicone rubber composition mass.

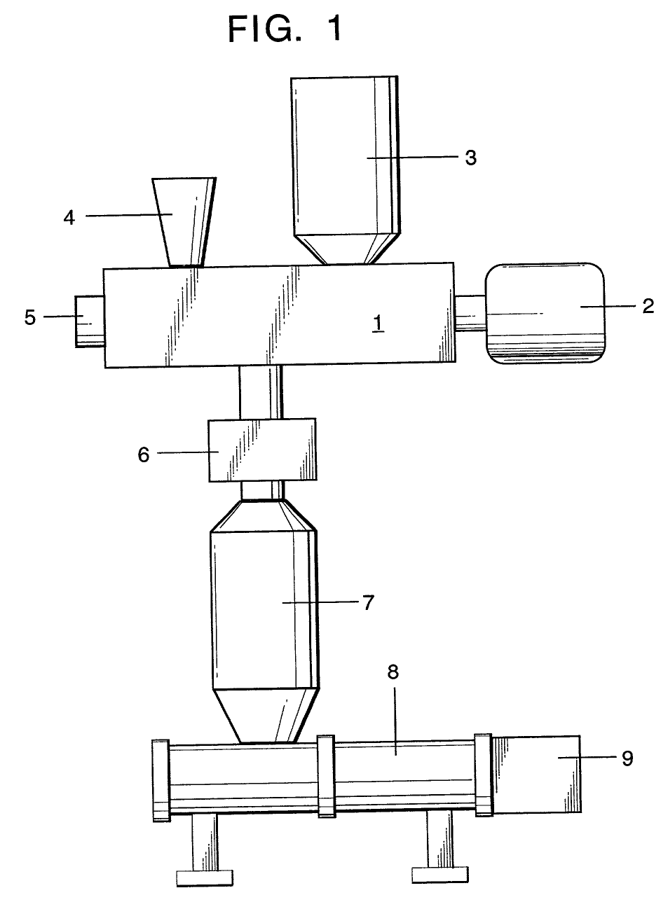

The present process is an integrated process. By “integrated” it is meant that after the batch formation of the powdered organosiloxane composition in step (A) that subsequent steps are conducted in a continuous mode without manual handling of the organosiloxane composition until after massing and preferable after addition of a peroxide catalyst and massing. A preferred equipment configuration suitable for practicing the present integrated process for manufacturing a peroxide catalyst containing silicone rubber composition is illustrated in FIG. 1. In FIG. 1, high-shear mixer 1 has attached thereto motor 2 for providing rotational energy to high shear blades contained therein (not shown), silica hopper 3, polydimethylsiloxane feed port 4, and feed port 5 for feeding the treating agent for the silica filler and optional ingredients as described herein. In the bottom of high-shear mixer 1 is an exit port connected to chopper 6. Chopper 6 empties into bulk solids cooling device 7. Bulk solids cooling device 7 feeds into extruder 8 which has attached at its exit end mixer 9.

Step (A) of the present process can be conducted in any mixing apparatus capable of maintaining the reinforcing filler in a fluidized state while blending the filler with the high consistency polydiorganosiloxane and applying sufficient shear to reduce the size of the resultant filler-coated polymer particles to an uniform powder. Suitable mixers include but are not limited to Waring (R) blenders containing a high speed shearing blade at the bottom of a vertically oriented conical chamber, mixers manufactured by Rheinstahl Henschel AG, Kassel, Germany, and mixer/granulators manufactured by Littleford Bros. Inc. Florence Ky.

A preferred mixer for use in the present process is the mixer/granulators manufactured by Littleford Bros. Inc. Such mixers and their use to form powdered silicone compositions are described, for example, in Link et al., U.S. Pat. No. 3,824,208 and Bilgrien et al., U.S. Pat. No. 5,153,238, which are hereby incorporated by reference for their teachings regarding such use. These mixers are referred to as “plow” or “plowshare” mixers due to the presence of at least one triangular or “T” shaped “plow” blade located in a horizontally oriented cylindrical mixing chamber. The plow blade rotates on the horizontal axis of the chamber with the edge of the blade close to the perimeter of the chamber. In addition to maintaining the silica in a fluidized state and uniformly dispersing the polymer particles throughout the silica to achieve a homogeneous blend, the plow blade is also believed to agglomerate the particles produced by the high speed shearing blade(s), also referred to as chopper blades, present in the chamber to achieve the desired final particle size.

The speed of the plow blade required to maintain the silica in a fluidized form is typically about 30 to about 200 revolutions per minute (rpm) and is dependent upon the capacity of the mixing chamber and the particle size range desired for the final powder. A speed of from 80 to 180 rpm is preferred using a 130 liter capacity mixing chamber. The speed would be proportionately slower for a larger capacity mixer.

The mixing chamber also contains at least one high speed chopping blade to provide the shearing force required to reduce the particle size of the polydiorganosiloxane to a fine powder. A preferred embodiment of a mixing chamber contains at least one conical array of 5 blades rotating on a single shaft and ranging in diameter from 15 to 23 cm, the smallest diameter blade being located closest to the mixer wall.

It is believed that the speed of the chopping blades(s) should be between about 2000 to about 4000 rpm to prepare the powdered silicone rubber composition of step (A), with a processing time of up to 30 minutes. The processing time period will vary depending upon the radius of the blade(s) and the volume of material in the mixer. Smaller diameter blades typically must rotate at a higher speed to impart the same level of shear to the present mixture. To minimize processing time it is preferable to use the longest chopper blades that will not interfere with rotation of the plow blades located on either side of the chopper blades

The high consistency polydiorganosiloxane is the major component of the silicone rubber composition formed by the present process and can have a viscosity within a range of about 6×10⁴ to 1×10⁸ mPa·s at 25° C. It is preferred that the high consistency polydiorganosiloxane have a viscosity within a range of about 1×10⁶ to 1×10⁷ mPa·s at 25° C.

The high consistency polydiorganosilaxane can be represented by the general formula R³(R¹R²SiO)ₙR³ where R¹, R², and R³ are each independently selected monovalent substituted or unsubstituted hydrocarbon groups and n, the average number of repeating units in the polymer, is selected to provide a viscosity within the ranges described above. The monovalent hydrocarbon groups represented by R¹, R², and R³ include alkyl and substituted alkyl groups containing from 1 to about 20 carbon atoms, alkenyl groups such as vinyl and 5-hexenyl, cycloalkyl groups such as cyclopentyl and cyclohexyl, and aromatic hydrocarbon groups such as phenyl, benzyl and tolyl. R¹, R², and R³ may be independently substituted with, for example, substituents such as halogens, alkoxy groups, and cyano groups. Preferred monovalent hydrocarbon radicals are selected from the group consisting of alkyl groups comprising 1 to about 4 carbon atoms, alkenyl, phenyl, and 3,3,3-trifluoropropyl. Most preferably each R¹ is independently selected from the group consisting of methyl and alkenyl groups comprising 1 to 5 carbon atoms, R² is methyl, and R³ is selected from the group consisting of methyl and alkenyl groups comprising 1 to 5 carbon atoms. The high consistency polydiorganosiloxane can be a homopolymer, a copolymer or a mixture containing two or more different homopolymers and/or copolymers. The high consistency polydiorganosiloxane can be, for example, trimethylsiloxy end-capped polydimethylsiloxane, vinyldimethylsiloxy end-capped polydimethylsiloxane, vinyldimethylsiloxy end-capped polydimethyl/vinylmethylsiloxane copolymer, and trimethylsiloxy end-capped polydimethyl/vinylmethylsiloxane copolymer.

Into step (A) of the present process is added about 10 to 80 parts by weight of a reinforcing silica filler for each 100 parts by weight of the high consistency polydiorganosiloxane. Such reinforcing silica fillers are well known in the art and can be any of those finely divided silicas having a surface area greater than about 50 m²/g and include fumed silica, precipitated silica, and silica gels. The preferred silica is a fumed silica having a surface area within a range of about 75 m²/g to 1000 m²/g. Preferred is when about 20 to 50 parts by weight of the reinforcing silica filler per 100 parts by weight of the high consistency polydiorganosiloxane is added to the present process in step (A).

Step (A) also requires the addition of a treating agent for the reinforcing silica filler. The treating agent can be any of those typically used to treated reinforcing silica fillers to make them more hydrophobic and to reduce or prevent a phenomena typically referred to as “creping” or “crepe hardening” that often occurs when mixture of such fillers and polydiorganosiloxanes are stored for any appreciable period of time. Creping is characterized by a gradual increase in the viscosity or decrease in the plasticity of such polydiorganosiloxane compositions. Although such crepe hardening can often be reversed by subjecting the composition to shearing forces using a rubber mill or sigma blade mixer, this adds an additional process step in the use of the composition and such step is preferably avoided.

Compounds which can be used as treating agents for the reinforcing silica fillers include, for example, liquid low-molecular weight silanol or alkoxy-terminated polydiorganosiloxanes, hexaorganodisiloxanes, hexaorganodisilazanes, cyclic diorganosiloxanes, and partial hydrolyzates of such compounds. A preferred treating agent for use in the present process is a low molecular weight hydroxy endblocked polydimethylsiloxane fluid.

The amount of treating agent can be any such amount that reduces or prevents crepe hardening of the silicone rubber composition prepared by the present method. Generally, a useful amount of treating agent is about 10 to 45 weight percent based on the weight of the reinforcing silica filler. Preferred is when about 15 to 35 weight percent of the treating agent is added in step (A) of the present process, based on the weight of the reinforcing silica filler.

Step (A) of the present process is conducted by adding at least a portion of the reinforcing silica filler to a high shear mixer and maintaining the filler in a highly turbulent fluidized state at a temperature of 80° C. to about 350° C. It is important that the temperature of the fluidized silica be maintained at a temperature of 80° C. or greater during conduct of step (A) both to facilitate treatment of the filler with the treating agent and to reduce the formation of gels. Preferred is when the temperature within the mixer is maintained within a range of about 100° C. To 180° C.

In a preferred embodiment of the present process, to reduce the capacity of the mixing chamber required to prepare a given amount of the blend, only a portion of the filler is added initially, due to the large increase in filler volume during fluidization. This volume decreases substantially as the silica densifies and coats the polydiorganosiloxane in the mixing chamber. The remaining filler is initially placed in a hopper or other suitable dispensing container and allowed to drop into the chamber as the volume of silica initially present in the mixer decreases due to coating of polydiorganosiloxane particles.

The high consistency polydiorganosiloxane is added to the mixer after at least a portion of the reinforcing silica filler has been added to the mixer and fluidized and the required temperature of the fluidized silica has been established. The initial size of the high consistency polydiorganosiloxane added to the mixer is not critical, and can range from a finely divided powder to the largest size pieces that can be conveniently fed to and will fit in the mixing chamber of the mixer. In a preferred process, the high consistency polydiorganosiloxane is added to the mixer as a single shot of one or more masses weighing up to about 100 kg each. The initial size of particles or a larger mass of polydiorganosiloxane added to the mixer is rapidly reduced by the shearing action of the mixer, which in the case of the Littleford-type mixer is provided by the chopper blades. Blending of the reinforcing silica filler with the high consistency polydiorganosiloxane is continued until the shearing force is sufficient to achieve an average particle size of from about 1 to 1000 microns thereby forming an organosiloxane composition in the form of a flowable powder. The length of time required to achieve such a particle size can vary from about 2 minutes to about 50 minute after addition of the polydiorganosiloxane, depending at least in part on the capacity of the mixer chamber and the shear force provided by the mixer.

In the preferred process using a Littleford-type mixer the reduction and subsequent increase in the particle size of the polydiorganosiloxane that occurs during step (A) can be monitored by plotting the amount of electrical power consumed by the motor(s) driving the chopper blades as a function of time. This method of assessing the particle size of the polydiorganosiloxane is described in Bilgrien et al., U.S. Pat. No. 5,153,238, which is hereby incorporated by reference for such a teaching.

In step (A) after the reinforcing silica filler is fluidized and the required temperature established the treating agent can be added prior to, during, or after addition of the polydiorganosiloxane. Preferred is when the treating agent is added during blending of the polydiorganosiloxane with the fluidized reinforcing silica filler.

In addition to the above described components (A)(i-iii), optional components can be added during step (A) depending upon the properties desired in the cured silicone elastomer prepared from the process. Such optional components include extending fillers such as quartz, calcium carbonate, and diatomaceous earth; pigments such as iron oxide and titanium oxide; electrically conducting fillers such as carbon black and finely divided metals; heat stabilizers such as hydrated cerric oxide; flame retardants such as antimony compounds, hydrated aluminum oxide, magnesium compounds and halogenated hydrocarbons; adhesion promoters; and resinous organosiloxane copolymers as reinforcing agents.

In the present integrated process when the desired particle size has been achieved, as indicated from the power consumption curve or by visual examination of the product, the powdered organosiloxane composition at a temperature of 80° C. or higher is directly transferred to a bulk solids cooling device to facilitate accelerated cooling of the powdered organosiloxane composition to a temperature below that of a subsequently to be added organoperoxide catalyst. The bulk solids cooling device can be any of those known in the art capable of facilitating the cooling of the powdered organosiloxane composition. Use of the term “facilitate” is use to distinguish from those situations where the bulk polydiorganosiloxane powder is allowed to cool relatively undisturbed under ambient conditions. Typically, although the powdered organosiloxane composition is free-flowing at this point it is somewhat sticky and easily massed if significant compaction occurs. Therefore, in choosing a bulk cooling device to facilitate cooling of the powdered organosiloxane compositions it is important to consider these characteristics of the powder. Suitable bulk cooling devices include, for example, belt coolers, jacketed mixers such as the above described Littleford-type mixer, fluidized mixers through which cooling air can be blown, and flow-through apparatus having one or more cooling elements positioned therein. A preferred bulk solids cooling device is that described in Mueller, U.S. Pat. No. 5,167,274, which is hereby incorporated by reference for such teaching.

Optionally, positioned in the flow path between the mixer of step (A) and the bulk solids cooling device can be a chopper or other such device to eliminate or reduce lumps, large particles, agglomerates and the like which could clog or otherwise compromise the capacity of the bulk solids cooling device. One example of such a device useful in the present process is described in Lynch et al., U.S. Pat. No. 4,768,722, which is hereby incorporated by reference for such teaching.

After the polydiorganosiloxane powder has been cooled to a temperature below the decomposition temperature of the organoperoxide to be added in subsequent steps, the powder is fed directly to an extruder suitable for forming the powder into a coherent mass. Any single or twin screw extruder capable of massing the powdered polydiorganosiloxane composition without generating significant heat may be used in this step. Preferred are those single screw extruders typically referred to as “cold feed” silicone rubber extruders such as manufactured by National Feed Screw (Massilon, Ohio) and Davis Standard (Mystic, Conn.). In a preferred process the exit end of the extruder is fitted with a screen to strain out particulates that may be present in the massed silicone rubber composition.

The peroxide catalyst may be added to the process anytime after the cooling of step (B); that is, after step (B) and before step (C), during step (C), or after step (C). The peroxide catalyst may be proportioned between two or more of the above described addition points. Because the preferred extruders for use in step (C) typically have poor mixing capabilities, it is preferred that the peroxide catalyst be added in a mixing step conducted after step (C). In the preferred integrated process, a mixing device is coupled directly to the exit end of the barrel of the extruder of step (C). Any of those low temperature distributive-type mixing devices known in the art can be used for this mixing step. Such mixing devices are described, for example, in MIXING IN POLYMER PROCESSING, Ed. By Rauwendaal, Marcel-Dekker, Inc., NY, 1991, pp. 164-187, in Gale U.S. Pat. No. 4,419,014, and in Saxton U.S. Pat. No. 3,006,029. A preferred mixer for use in the present process is a cavity transfer type mixer as described in the above citations. In the preferred process the catalyzed silicone rubber composition is shaped into a suitable form for shipping and handling by means of a die positioned at the exit end of the extruder or when a separate mixer is used at the exit end of the mixer.

The organoperoxide catalyst added to the present process can be any of those typically added to silicone compositions to effect curing. The organoperoxide catalyst can be vinyl specific and require the presence of vinyl or other alkenyl groups substituted on the polydiorganosiloxane polymers. The organoperoxide can be non-vinyl specific, and react with hydrocarbon groups bonded to silicon atoms of the high consistency polydiorganosiloxane to generate a free radical at which cross-linking can be effected. The organoperoxide catalyst can include di-tertiary butyl peroxide, tertiary-butyl-triethylmethyl peroxide, tertiary-butyl-tertiary-butyl-tertiary-triphenyl peroxide, t-butyl perbenzoate and di-tertiary alkyl peroxides such as dicumyl peroxide and 2,5-bis(tert-butyl peroxy)-2,5-dimethylhexane. Other suitable peroxide catalyst which effect curing through saturated as well as unsaturated hydrocarbon groups on the siloxane chains are aryl peroxides such as tertiary-butyl perbenzoate, chloroalkyl peroxides such as 1,3-dichlorobenzoyl peroxide, 2,4-dichlorobenzoyl peroxide, monochlorobenzoyl peroxide, and benzoyl peroxide. A preferred organoperoxide catalyst is selected from the group consisting of 2,4-dichlorobenzoyl peroxide and 2,5-bis(tertiarybutyl peroxy)-2,5-dimethyl hexane.

A catalytic amount of the organoperoxide catalyst is added to the organosiloxane composition. The catalytic amount of the organoperoxide catalyst is that sufficient to effect cure of the organosiloxane composition when heated above the decomposition temperature of the organoperoxide. Generally, about 0.1 to 10 weight percent of the organoperoxide can be added to the organosiloxane composition, based upon the weight of the organosiloxane composition.

An organoperoxide catalyst containing silicone rubber composition mass is obtained from the present process. In the preferred process the massed silicone rubber composition is extruded from the extruder or mixer into a size and configuration suitable for further processing in molding and extruding applications. The final size and configuration of the material produced by the present process is not critical and will be generally dictated by the requirements of the final use of the composition.

### EXAMPLE

Into a Littleford Mixer such as described in Link et al., U.S. Pat. No. 3,824,208, having a mixing chamber capacity of 1200 liter and heated to 93° C., was fed 264 kg of Alumina Micral 9400 SP ( J. M. Huber Corp., Edison, N.J.) and 44 kg of fumed silica having a surface area of 75 m² /g. Then, over about a 4 minute period, 102 kg of vinyl substituted polydimethylsiloxane gum and 52 kg of a hydroxy endblocked polydimethylsiloxane were fed to the reactor. Next, 2.6 kg of 50 wt % zinc stearate in silicone fluid and 7.2 kg 40 wt % pigment in silicone fluid were added to the mixer. A treating agent mixture comprising 16.1 kg of a low molecular weight (LMW) hydroxy endblock polydimethylsiloxane fluid, 8.5 kg of a LMW hydroxy endblocked phenylmethylsiloxane fluid, and 0.5 kg of a LMW hydroxy endblocked methylvinylsiloxane fluid along with ammonium hydroxide as catalyst was added to the mixer. Mixing was continued for 11 minutes to effect treatment of the fillers, then the pressure within the mixer was reduced to 4.5 psia to remove volatile species and mixing continued for an additional 3 minutes. The mixer content (silicone rubber base) was discharged through a powder mill to remove large aggregates and then passed to a powder cooler such as that described in Lynch et al., U.S. Pat. No. 4,768,722. The temperature of the silicone rubber base was about 115° C. exiting the mixer and in a range of 43-77° C. exiting the powder cooler. The powder cooler was equipped with a vibratory discharger through which the cooled silicone rubber base was fed to an 8 inch vented cold feed silicone rubber extruder (National Feed Screw, Massilon Ohio). The barrel of the extruder contained 4 zones: an intake compression zone, a vacuum de-airing zone, a second compression/metering zone, and a 6-row cavity transfer mixer containing two injection ports. A peroxide catalyst was fed into the two injection ports to form a curable silicone rubber composition. The curable silicone rubber composition was passed through a 120 mesh screen positioned at the end of the extruder and package for storage and shipment. The process was operated in a semi-continuous mode by as soon as the mixer was emptied starting another batch of materials through the process. The time for running 4 such batches of material through the process was about 5 hours. Samples of each of the batches of curable silicone rubber were taken and the Williams Plasticity (mm×100) and specific gravity were determined and are reported in Table 1. In addition, samples of each batch of the curable silicone rubber composition were cured at 177 ° C. and the physical properties as reported in Table 1 determined. Tensile, Modulus (100% @ elongation), and Elongation where determined by ASTM 412. Durometer (Shore A) was determined by ASTM D2240.

TABLE 1
Physical Properties of Silicone Rubber Composition
Prepared by an Integrated Process

| | Run No. | | | |
|---|---|---|---|---|
| Property | 1 | 2 | 3 | 4 |
| Elongation (%) | 252 | 250 | 251 | 251 |
| Durometer | 63 | 60 | 64 | 64 |
| (Shore (A) | | | | |
| Tensile (MPa) | 4.96 | 4.51 | 5.09 | 4.72 |
| Modulus (MPa) | 2.32 | 2.06 | 2.40 | 2.21 |
| Plasticity | 250 | 217 | 263 | 240 |
| (mm × 100) | | | | |
| Spec. Gravity | 1.56 | 1.55 | 1.56 | 1.55 |

We claim:

1. An integrated process for compounding a peroxide catalyst containing silicone rubber composition comprising the steps of
A) blending a composition comprising i) 100 parts by weight of a high consistency polydiorganosiloxane, ii) about 10 to 80 parts by weight of a reinforcing silica filler, and iii) about 10 to 45 weight percent, based on the weight of the reinforcing silica filler, of a treating agent for the reinforcing silica filler by maintaining the filler in a highly turbulent, fluidized state at a temperature of 80° C. to about 350° C. and maintaining the temperature and highly turbulent fluidized state while subjecting the blend to shearing force sufficient to achieve an average particle size of from 1 to 1000 microns thereby forming an organosiloxane composition in the form of a flowable powder,
B) facilitating accelerated bulk cooling of the organosiloxane composition to a temperature below the decomposition temperature of an organoperoxide catalyst added in step (D),
C) feeding the bulk cooled organosiloxane composition to an extruder and massing the composition therein at a temperature below the decomposition temperature of an organoperoxide catalyst added in step (D),
D) adding a catalytic amount of an organoperoxide catalyst to the organosiloxane composition either prior to, during, or after step C at a temperature below the decomposition temperature of the organoperoxide catalyst, and
E) recovering an organoperoxide catalyst containing silicone rubber composition mass.

2. An integrated process according to claim 1, where the high consistency polydiorganosiloxane has a viscosity within a range of about 6×10⁴ to 1×10⁸ mPa·s at 25° C.

3. An integrated process according to claim 1, where the high consistency polydiorganosiloxane has a viscosity within a range of about 1×10⁶ to 1×10⁷ mPa·s at 25° C.

4. An integrated process according to claim 1, where the high consistency polydiorganosiloxane is selected from the group consisting of trimethylsiloxy end-capped polydimethylsiloxane, vinyldimethylsiloxy end-capped polydimethylsiloxane, vinyldimethylsiloxy end-capped polydimethyl/vinylmethylsiloxane copolymer, and trimethylsiloxy end-capped polydimethyl/vinylmethylsiloxane copolymer.

5. An integrated process according to claim 1, where the reinforcing silica filler is a fumed silica having a surface area within a range of about 75 m²/g to 1000 m²/g.

6. An integrated process according to claim 5 comprising about 20 to 50 parts by weight of the reinforcing silica filler per 100 parts by weight of the high consistency polydioganosiloxane.

7. An integrated process according to claim 1, where the treating agent is a low molecular weight hydroxy endblocked polydimethylsiloxane fluid.

8. An integrated process according to claim 1 comprising about 15 to 35 weight percent of the treating agent, based on the weight of the reinforcing silica filler.

9. An integrated process according to claim 1, where in step (A) the temperature is within a range of about 100° C. to 180° C.

10. An integrated process according to claim 1, where organoperoxide catalyst is selected from the group consisting of 2,4-dichlorobenzoyl peroxide and 2,5-bis(tertiarybutyl peroxy)-2,5-dimethylhexane.

11. An integrated process according to claim 1 comprising about 0.1 to 10 weight percent of the organic peroxide, based on the weight of the composition.

12. An integrated process according to claim 1, where the peroxide catalyst is added in a mixing step conducted after step (C).
